(19) United States
(12) Patent Application Publication
(10) Pub. No.: US 2007/0126963 A1
(43) Pub. Date: Jun. 7, 2007

(54) Transflective liquid crystal display device

(75) Inventors: Chiu-Lien Yang, Miao-Li (TW); Wei-Yi Ling, Miao-Li (TW); Chia-Lung Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/607,725

(22) Filed: Dec. 1, 2006

(30) Foreign Application Priority Data
Dec. 1, 2005 (CN) 200510102119.0

(51) Int. Cl. G02F 1/1335

(52) U.S. Cl. 349/119; 349/114

(57) ABSTRACT

An exemplary transflective LCD device (200) includes: a first substrate (220); a second substrate (210); a liquid crystal layer (230) interposed between the substrates; a first polarizer (224) disposed at a surface of the first substrate opposite to the liquid crystal layer; a second polarizer (214) disposed at a surface of the second substrate opposite to the liquid crystal layer; a first retardation film (222) disposed between the first polarizer and the first substrate; a second retardation film (223) disposed between the first retardation film and the first polarizer; a third retardation film (212) disposed between the second polarizer and the second substrate; a fourth retardation film (214) disposed between the third retardation film and the second polarizer; and a first discotic molecular film (221) disposed between the first retardation film and the first substrate.

### CROSS-REFERENCE TO RELATED APPLICATION

This application is related to an application by CHIU-LIEN YANQ WEI-YI LING and CHIA-LUNG LIN entitled LIQUID CRYSTAL DISPLAY DEVICE, filed before the present application, and assigned to the same assignee as that of the present application.

### FIELD OF THE INVENTION

The present invention relates to liquid crystal display (LCD) devices, and more particularly to a reflection/transmission type LCD device capable of providing a display both in a reflection mode and a transmission mode.

### BACKGROUND

Conventionally, there have been three types of LCD devices commercially available: a reflection type LCD device utilizing ambient light, a transmission type LCD device utilizing backlight, and a semi-transmission type LCD device equipped with a half mirror and a backlight.

With a reflection type LCD device, a display becomes less visible in a dim environment. In contrast, with a transmission type LCD device, a display becomes hazy in strong ambient light (e.g., outdoor sunlight). Thus researchers sought to provide an LCD device capable of functioning in both modes so as to yield a satisfactory display in any environment. In due course, a semi-transmission type LCD device was disclosed in Japanese Laid-Open Publication No. 7-333598.

However, the above-mentioned semi-transmission type LCD device typically has the following problems.

The semi-transmission type LCD device uses a half mirror in place of a reflective plate used in a reflection type LCD device, and has a minute transmission region (e.g., minute holes in a metal thin film) in a reflection region, thereby providing a display by utilizing transmitted light as well as reflected light. Since reflected light and transmitted light used for a display pass through the same liquid crystal layer, an optical path of reflected light is twice as long as that of transmitted light. This causes a large difference in retardation of the liquid crystal layer with respect to reflected light and transmitted light. Thus, a satisfactory display may not be obtained. Furthermore, a display in a reflection mode and a display in a transmission mode are superimposed on each other, so that the respective displays cannot be separately optimized. This results in difficulty in providing a color display, and tends to cause a blurred display.

Accordingly, what is needed is an LCD device that can overcome the above-described deficiencies.

### SUMMARY

A transflective LCD device includes: a first substrate; a second substrate; a liquid crystal layer interposed between the substrates; a first polarizer disposed at a surface of the first substrate opposite to the liquid crystal layer; a second polarizer disposed at a surface of the second substrate opposite to the liquid crystal layer; a first retardation film disposed between the first polarizer and the first substrate; a second retardation film disposed between the first retardation film and the first polarizer; a third retardation film disposed between the second polarizer and the second substrate; a fourth retardation film disposed between the third retardation film and the second polarizer; and a first discotic molecular film disposed between the first retardation film and the first substrate.

Other objects, advantages, and novel features will become more apparent from the following detailed description when taken in conjunction with the accompanying drawings.

### BRIEF DESCRIPTION OF THE DRAWINGS

FIG. 1 is a schematic, exploded, side cross-sectional view of part of a transflective LCD device according to a first embodiment of the present invention.

FIG. 2 shows a polarized state of light in each of certain layers of the transflective LCD device of FIG. 1, in respect of an on-state (white state) and an off-state (black state) of the transflective LCD device, when the transflective LCD device operates in a reflection mode.

FIG. 3 shows a polarized state of light in each of certain layers of the transflective LCD device of FIG. 1, in respect of an on-state (white state) and off-state (black state) of the transflective LCD device, when the transflective LCD device operates in a transmission mode.

FIG. 4 is a schematic, exploded, side cross-sectional view of part of a transflective LCD device according to a second embodiment of the present invention.

### DETAILED DESCRIPTION OF PREFERRED EMBODIMENTS

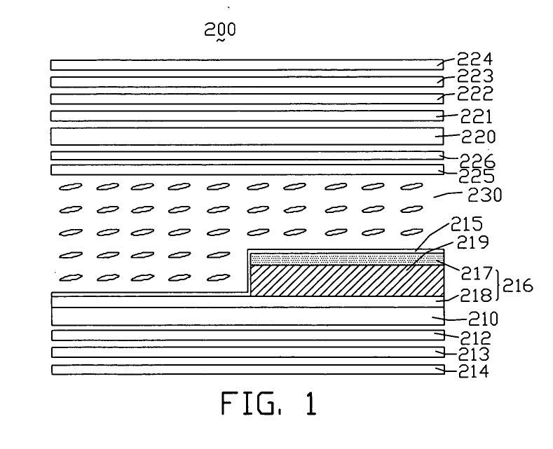

FIG. 1 is a schematic, exploded, side cross-sectional view of part of a transflective LCD device 200 according to a first embodiment of the present invention. The LCD device 200 includes a first substrate 220, a second substrate 210 disposed parallel to and spaced apart from the first substrate 220, a liquid crystal layer 230 having liquid crystal molecules (not labeled) sandwiched between the substrates 220 and 210, a first alignment film 225 disposed between the first substrate 220 and the liquid crystal layer 230, and a second alignment film 215 disposed between the second substrate 210 and the liquid crystal layer 230.

The first and second alignment films 225 and 215 are homogeneous alignment films. A rubbing direction of the first alignment film 225 is parallel to that of the second alignment film 215. A pre-tilt angle of the liquid crystal molecules adjacent to the first and second alignment films 225 and 215 is in a range of 0° to 15°.

A first discotic molecular film 221, a first retardation film 222, a second retardation film 223, and a first polarizer 224 are disposed in that order on an outer surface of the first substrate 220. A third retardation film 212, a fourth retardation film 213, and a second polarizer 214 are disposed in that order on an outer surface of the second substrate 210.

An alignment direction of molecules in the first discotic molecular film 221 is parallel to that of the alignment films 225 and 215. A pre-tilt angle of the molecules in the first discotic molecular film 221 adjacent to the first substrate 220 is defined as θ_{DLC1}, and is in a range from 0° to 45°. A pre-tilt angle of molecules in the first discotic molecular film 221 adjacent to the first retardation film 222 is defined as θ_{DLC2}, and is in a range from 45° to 90°.

The first and third retardation films 222 and 212 are preferably quarter-wave plates. The second and fourth retardation films 223 and 213 are preferably half-wave plates. A slow axis of the second retardation film 223 maintains an angle θ₁ relative to the polarizing axis of the first polarizer 224, and a slow axis of the first retardation film 222 maintains an angle 2θ₁°±45° relative to the polarizing axis of the first polarizer 224. A slow axis of the fourth retardation film 213 maintains an angle θ₂ relative to the polarizing axis of the second polarizer 214, and a slow axis of the third retardation film 212 maintains an angle 2θ₂°±45° relative to the polarizing axis of the second polarizer 214.

The polarizing axis of the first polarizer 224 is perpendicular to that of the second polarizer 214. When θ₁ is equal to θ₂, the slow axis of the first retardation film 222 is perpendicular to that of the third retardation film 212, and the slow axis of the second retardation film 223 is perpendicular to that of the fourth retardation film 213.

A common electrode 226 is disposed on an inner surface of the first substrate 220. The common electrode 226 is made of a transparent conductive material, such as indium-tin-oxide (ITO) or indium-zinc-oxide (IZO).

A pixel electrode 216 and an insulating layer 219 are disposed on an inner surface of the second substrate 210. The pixel electrode 216 includes a reflection electrode 217 and a transmission electrode 218. The reflection electrode 217 is made of metal with a high reflective ratio, such as aluminum (Al) or an aluminum-neodymium (Al—Nd) alloy. The reflection electrode 217 is used for reflecting ambient light when the LCD device 200 operates in a reflection mode. The transmission electrode 218 is made of a transparent conductive material, such as indium-tin-oxide (ITO) or indium-zinc-oxide (IZO). The insulating layer 219 separates the reflection electrode 217 from the pixel electrode 216.

The LCD device 200 includes a plurality of pixel regions that span through the common electrode 226, the pixel electrode 216, and the liquid crystal layer 230 contained between the common and pixel electrodes 226, 216. Each of the pixel regions includes a reflection region (not labeled) corresponding to the reflection electrode 217, and a transmission region (not labeled) corresponding to a portion of the transmission electrode 218 not overlapped by the reflection electrode 217. The retardation value of the liquid crystal layer 230 in the transmission region is in the range from 130 nm˜350 nm, and the retardation value of the liquid crystal layer 230 in the reflection region is in the range from 65˜175 nm.

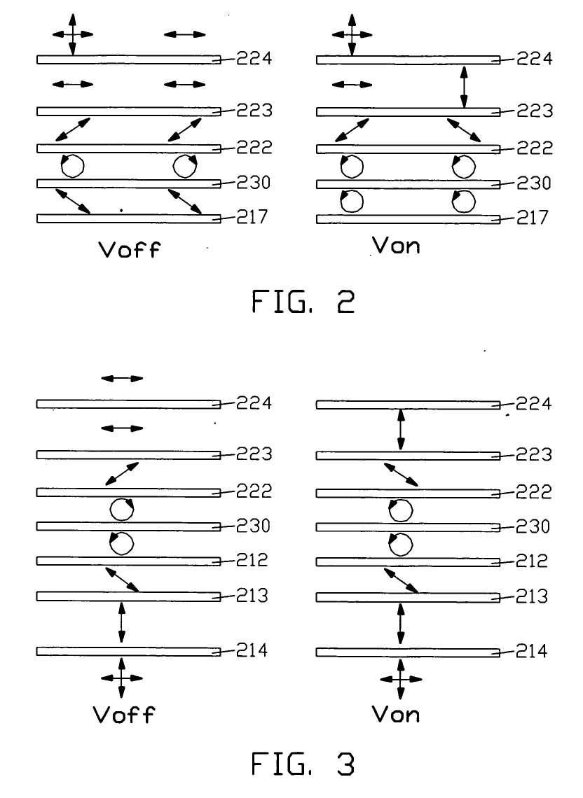

FIG. 2 shows a polarized state of light in each of certain layers of the LCD device 200 when the LCD device 200 operates in a reflection mode. When no voltage is applied to the LCD device 200, the LCD device 200 is in an on-state (white state). Ambient incident light becomes linearly-polarized light having a polarizing direction parallel to that of the first polarizer 224 after passing through the first polarizer 224. Then the linearly-polarized light passes through the second retardation film 223 (a half-wave plate). The polarized state of the linearly-polarized light is not changed, and the polarizing direction thereof twists by an amount of 20. Thereafter, the linear-polarized light is incident upon the first retardation film 222 (a quarter-wave plate), and becomes circularly-polarized light. Then the circularly-polarized light is incident on the liquid crystal layer 230. Since an effective phase difference of the liquid crystal layer 230 in an on-state is adjusted to a wavelength of λ/4 in order to obtain a white display, the incident circularly-polarized light becomes linearly-polarized light. The linearly-polarized light exiting the liquid crystal layer 230 is reflected by the reflection electrode 217. The linearly-polarized light keeps its polarized state, and is incident on the liquid crystal layer 230 again. The linearly-polarized light passing through the liquid crystal layer 230 becomes circularly-polarized light having a polarizing direction opposite to that of the circularly-polarized light originally incident on the liquid crystal layer 230. The circularly-polarized light exiting the liquid crystal layer 230 is converted to linearly-polarized light by the quarter-wave plate 222. Thereafter, the linearly-polarized light passes through the half-wave plate 223, and is output through the first polarizer 224 for displaying images.

On the other hand, when a voltage is applied to the LCD device 200, the LCD device 200 is in an off-state (black state). Up to the point where ambient incident light reaches the liquid crystal layer 230, the ambient incident light undergoes transmission in substantially the same way as described above in relation to the LCD device 200 being in the on-state. Since an effective phase difference of the liquid crystal layer 230 is adjusted to be 0 by applying a voltage in order to obtain a black display, the circularly-polarized light incident on the liquid crystal layer 230 passes therethrough as circularly-polarized light. The circularly-polarized light exiting the liquid crystal layer 230 is reflected by the reflection electrode 217. The circularly-polarized light keeps its polarized state, and is incident on the liquid crystal layer 230 again. After passing through the liquid crystal layer 230, the circularly-polarized light is converted into linearly-polarized light by the first retardation film 222 (a quarter-wave plate). At this time, the polarizing direction of the linearly-polarized light is rotated by about 90° compared with that of a white display state. Then the linearly-polarized light passes through the second retardation film 223 (a half-wave plate), and is absorbed by the first polarizer 224. Thus the linearly-polarized light is not output from the LCD device 200 for displaying images.

FIG. 3 shows a polarized state of light in each of certain layers of the LCD device 200 for an on-state (white state) and an off-state (black state) when the LCD device 200 operates in a transmission mode. Incident light undergoes transmission in a manner similar to that described above in relation to the LCD device 200 operating in the reflection mode. An effective phase difference of the liquid crystal layer 230 in an on-state is adjusted to a wavelength of λ/2.

The first, second, third, and fourth retardation films 222, 223, 212 and 213 can compensate the phase difference generated by the liquid crystal molecules that may not be completely perpendicular to the substrates 220 and 210 when voltage is provided thereto. This reduces the leakage of light when the LCD device 200 in an off-state, and increases a contrast of images displayed by the LCD device 200. Moreover, the first discotic molecular film 221 can compensate contrast and color-shift of the LCD device 200 according to different viewing angles, so as to improve a wide viewing angle performance of the LCD device 200.

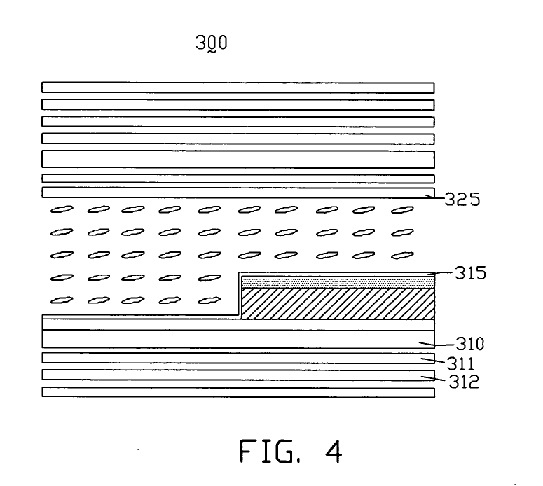

FIG. 4 is a schematic, exploded, side cross-sectional view of part of a transflective LCD device 300 according to a second embodiment of the present invention. The LCD device 300 has a structure similar to that of the LCD device 200. However, the LCD device 300 further includes a second discotic molecular film 311 disposed between a third retardation film 312 and a second substrate 310.

An alignment direction of molecules in the second discotic molecular film 311 is parallel to that of first and second alignment films 325 and 315. A pre-tilt angle of the molecules in the second discotic molecular film 311 adjacent to the second substrate 310 is defined as θ_{DLC1}, and is in a range from 0° to 45°. A pre-tilt angle of the molecules in the second discotic molecular film 311 adjacent to the third retardation film 312 is defined as θ_{DLC2}, and is in a range from 45° to 90°.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A transflective liquid crystal display device, comprising:
a first substrate and a second substrate;
a liquid crystal layer having liquid crystal molecules interposed between the first and second substrates;
a first polarizer disposed at a surface of the first substrate opposite to the liquid crystal layer;
a second polarizer disposed at a surface of the second substrate opposite to the liquid crystal layer;
a first retardation film disposed between the first polarizer and the first substrate;
a second retardation film disposed between the first retardation film and the first polarizer;
a third retardation film disposed between the second polarizer and the second substrate;
a fourth retardation film disposed between the third retardation film and the second polarizer; and
a first discotic molecular film disposed between the first retardation film and the first substrate.

2. The transflective liquid crystal display device as claimed in claim 1, further comprising a first alignment film disposed between the liquid crystal layer and the first substrate, and a second alignment film disposed between the liquid crystal layer and the second substrate, wherein a rubbing direction of the first alignment film is parallel to that of the second alignment film.

3. The transflective liquid crystal display device as claimed in claim 2, wherein a pre-tilt angle of molecules in the first discotic molecular film adjacent to the first substrate is in the range from 0° to 45°, and a pre-tilt angle of molecules in the first discotic molecular film adjacent to the first retardation film is in the range from 45° to 90°.

4. The transflective liquid crystal display device as claimed in claim 1, wherein the first and third retardation films are quarter plates, and the second and fourth retardation films are half-wave plates.

5. The transflective liquid crystal display device as claimed in claim 4, wherein a slow axis of the second retardation film maintains an angle θ₁ relative to a polarizing axis of the first polarizer, a slow axis of the first retardation film maintains an angle 2θ₁°±45° relative to the polarizing axis of the first polarizer, a slow axis of the fourth retardation film maintains an angle θ₂ relative to a polarizing axis of the second polarizer, and a slow axis of the third retardation film maintains an angle 2θ₂°±45° relative to the polarizing axis of the second polarizer.

6. The transflective liquid crystal display device as claimed in claim 1, further comprising a common electrode disposed at an inner surface of the first substrate in each of pixel regions of the transflective liquid crystal display device, and a pixel electrode is disposed at an inner surface of the second substrate in each of the pixel regions, wherein the common electrode, the pixel electrode, and the portion of the liquid crystal layer contained between the common and pixel electrodes form the pixel region, the pixel region includes a reflection region and a transmission region, a retardation of the portion of the liquid crystal layer in the transmission region is in the range from 130 mm˜350 nm, and a retardation of the portion of the liquid crystal layer in the reflection region is in the range from 65˜175 nm.

7. The transflective liquid crystal display device as claimed in claim 6, wherein the pixel electrode includes a reflection electrode and a transmission electrode, the reflection electrode is made of metal with a high reflective ratio, and the transmission electrode is made of a transparent conductive material.

8. The transflective liquid crystal display device as claimed in claim 1, further comprising a second discotic molecular film disposed between the third retardation film and the second substrate.

9. The transflective liquid crystal display device as claimed in claim 8, wherein a pre-tilt angle of molecules in the second discotic molecular film adjacent to the second substrate is in the range from 0° to 45°, and a pre-tilt angle of molecules in the second discotic molecular film adjacent to the third retardation film is in the range from 45° to 90°.
